(19) United States
(12) Patent Application Publication
(10) Pub. No.: US 2009/0150795 A1
(43) Pub. Date: Jun. 11, 2009

(54) Object model and user interface for reusable map web part

(75) Inventors: Rachna Vargiya, Sammamish, WA (US); David C. Johnson, Redmond, WA (US); Jad Honien, Redmond, WA (US); Elia Karagiannis, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/953,891

(22) Filed: Dec. 11, 2007

(51) Int. Cl. G06F 3/00

(52) U.S. Cl. 715/744

(57) ABSTRACT

Architecture that enables an end user interested in rendering a map in a web-based collaboration and document management platform the ability to do so without writing custom code. The architecture includes a map server control for insertion into a web page to display a map view. The end user can also employ a pushpin database to store different landmarks to be displayed on the map view. An administrator server control is provided for managing the content (e.g., landmark data) of the database, and a legend server control for providing a list of landmark data for selection and presentation in the map view. A data interface facilitates access to the pushpin database for administrator functions and pushpin information for presentation and selection.

### BACKGROUND

The Internet has made possible access to a myriad of information. Initially beginning as a convenient means to exchange information between users, the Internet now has evolved to serve a wide variety of more robust functions such as conferencing, collaboration, and so on. Websites can now be employed as portals for collaboration and document management. The browser application, the most widely used means for accessing information on the Internet, can be used to access shared workspaces and documents, as well as specialized applications such as blogs.

In one implementation of a document management and collaboration platform, functionality is exposed in the form of web parts. Web parts are ASP.net server controls that can be utilized for creating web pages directly from a browser. Thus, users can modify a user interface of the website directly via the browser. The web parts are reusable and do not require that the end user perform special coding.

However, conventional platforms do not offer a solution for integrating a map experience with a website. The end user must integrate this experience using custom code written and designed for this particular purpose. Moreover, in order to display pushpins on a map, a datasource is required that is integrated with the map, thereby requiring a well thought-out design and an extensive coding cycle to implement and test.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables an end user interested in rendering a map in a web-based collaboration and document management platform the ability to do so without writing custom code. The architecture includes a map server control for insertion into a web page to display a map view. A pushpin database is provided to store different landmark data to be displayed on the map view. An administrator server control is provided for managing the content (e.g., landmark data) of the database, and a legend server control provides a list of landmark data to the map server control for selection and presentation in the map view. A data interface facilitates access to the pushpin database for administrator functions and pushpin information for presentation and selection.

In one implementation, the map server control is a map web part as associated with an ASP.net framework which that can be dragged and dropped into a web page to display a variable sized map view. The end user can also employ a pushpin database to store different landmarks to be displayed on the map. An administrator user interface (UI) web part is provided for managing the content of this database, and also an object model to manage content programmatically.

In addition, the user can use an existing datasource (e.g. SQL server) to render pushpins in the map by adhering to the disclosed architecture and installing the associated stored procedures. Additionally, an application programmable interface (API) can be utilized for implementation to integrate the existing datasource with the map, and with a considerably lower amount of custom code. The entire configuration can be performed by the user. If the user chooses to use the default datasource, then no custom code is needed. In other words, the end user can reuse maps without having to write and call specially-written APIs and custom data.

The use of the disclosed map web part solves the database schema design conventionally required to store the related data for the map, and provides an additional web part to manage the map content through the platform.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented map rendering system.

FIG. 2 illustrates an alternative map rendering system.

FIG. 3 illustrates an exemplary database schema for storing the pushpin data.

FIG. 4 illustrates a computer-implemented method of providing a map in a web page.

FIG. 5 illustrates a method of obtaining and populating a map with pushpin data.

FIG. 6 illustrates a method of managing a database of landmark data for a mapping process.

FIG. 7 illustrates an exemplary web page exposed via a browser that incorporates an enterprise map populated by pushpin landmark data.

FIG. 8 illustrates an exemplary web page exposed via the browser that incorporates an administrator web part.

FIG. 9 illustrates a block diagram of a computing system operable to support the disclosed map server control rendering system.

### DETAILED DESCRIPTION

The disclosed architecture is a reusable solution that enables an end user interested in rendering a map in a web-based collaboration and document management platform the ability to do so without writing custom code. The architecture enables users to integrate 2D and 3D maps in an environment, and use a database or other datasource to store pushpin data for presenting landmarks on the map.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

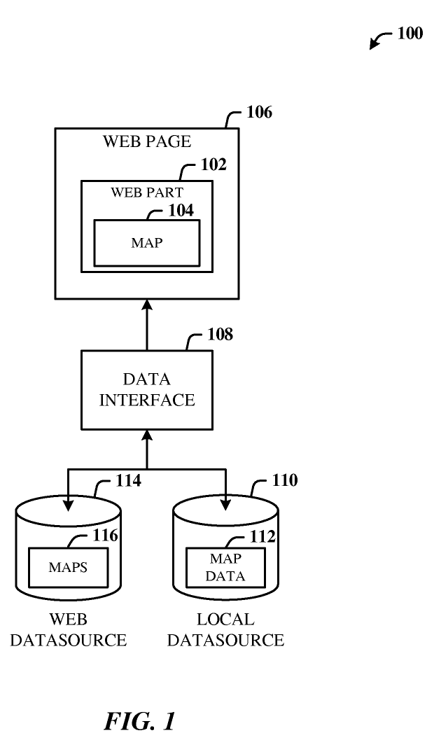

FIG. 1 illustrates a computer-implemented map rendering system 100. The system 100 includes a web part 102 for presenting a map 104 in a web page 106, and a data interface 108 for managing access to a datasource 110 that includes map data 112 (e.g., pushpin). The map data 112 is used to populate the map 104 in support of presenting a specific map view.

The map data 112 can include pushpin data related to landmarks that are rendered in the map view. The web part 102 can be a map web part that retrieves the map 104 from a map application system. In one implementation, the map 104 is retrieved from a local distribution media such as a hard disk, optical media (e.g., DVD, CD), etc. Alternatively, or in combination therewith, the map 104 can be obtained from a web-based 3D (or 2D) geographical information system server datasource 114 (e.g., Virtual Earth™ by Microsoft Corporation) that generates maps 116 for access and download. The web part 102 queries the data interface 108 for the map data 112 to render in the map view. For example, landmark data can be rendered as pushpins on the map view.

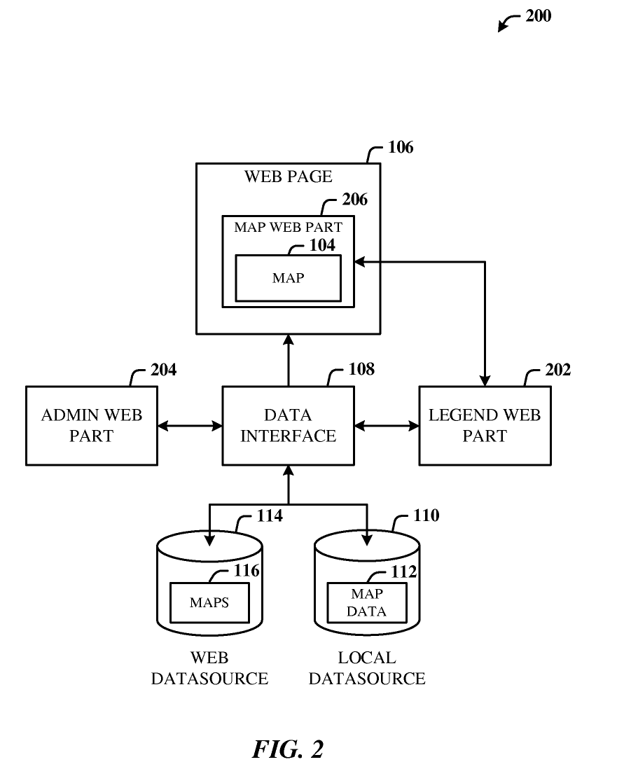

FIG. 2 illustrates an alternative map rendering system 200. The system 200 includes the system 100 in addition to a legend web part 202 and an administrator web part 204. The web part 102 depicted in FIG. 1 is now shown more specifically as a map web part 206. The map web part 206 facilitates a user interface that is modifiable using a browser application. The system 200 further can include a legend web part 202 for notifying the map web part 206 of one or more landmarks to render. In other words, the legend web part 202 provides a list of pushpin types to display on the map web part 206 for selection and rendering in a specific map view. The data is retrieved from the datasource. The system 200 further comprises an administrator web part 204 for managing the map data 112 in the map data datasource 110. The administrator web part 204 also facilitates adding and editing the map data 112 manually.

More generally, the data interface 108 is used for all communication with the map data datasource 110. The map web part 206 queries the data interface 108 to provide the pushpin data, for example, from the map data datasource 110 for rendering on the map 104. The legend web part 202 notifies the map web part 206 in the web page 106 of which landmarks to render. The data in the datasources 110 is managed through an administrator web part 204, which also uses the data interface 108 to communicate with the datasource 110 (e.g., a database of map data).

The map data datasource 110 is a database that stores corporate landmark information that will be exposed globally to users for use generating the specific map view. The landmark information can include major structures and associated identification information (e.g., geographic, addresses, etc.) for company building information, library information, visitor centers, parking, etc. The data interface 108 is structured on top of the database. Where the company maintains a datasource of information for other purposes and uses a different database schema, the company can implement the data interface 108 to obtain the benefits of the disclosed architecture. Generally, the data interface 108 assists the other web parts (e.g., legend, admin) in communicating with the datasource 110 and for sending information back and forth between the web parts and other entities of the system 200.

The map web part 206 calls the map application API's to render the map 104 within a skin for deployment without the end user needing to write custom code. Without the map web part 206, an end user desiring to integrate the disclosed map experience would have to call the map application API and build classes each time the map was arranged in the environment.

The administrator web part 204 functions as a UI for pushing data to the datasource 110. The datasource 100 can be populated using a data feed (e.g., RSS). In an alternative implementation, however, administrators can add data manually and/or edit data that already exists in the datasource 110 for the presentation of more accurate information in the map web part 206. The administrator web part 204 allows the administrator to manage the data 112 in the datasource 110 that is being rendered in the map 104.

The legend web part 202 accesses and exposes the landmark information stored in the datasource 110. The legend web part 202 is a small UI web part which lists all of the landmark information and a legend to the map 104. The end user can enable and disable which pushpins will be presented on the map 104 using this legend web part 202.

In other words, the data interface 108 allows the administrator to set and get data to the datasource 110 via the administrator web part 204, retrieve and send pushpin data to the legend web part 202, handle set and get data operations for any of the web parts, and provide all data to be rendered in the specific view to the map web part 106. Once determined, the legend web part 202 provides a list of selected pushpins to the map web part 106 that will be rendered in the map.

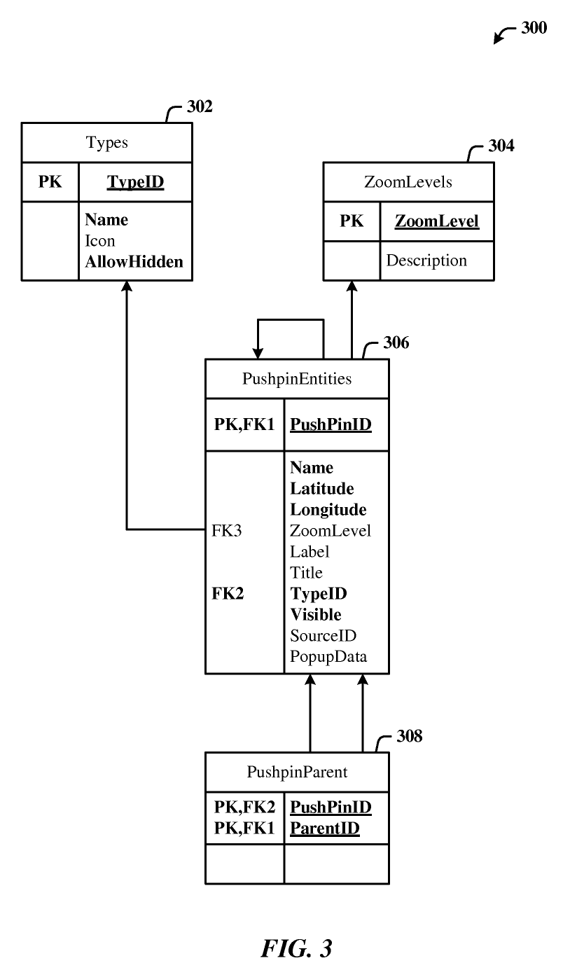

FIG. 3 illustrates an exemplary database schema 300 for storing the pushpin data. The schema 300 includes a Types entity 302, ZoomLevels entity 304, PushpinEntities entity 306 and PushpinParent entity 308. The Types entity 302 includes a TypeID attribute and properties of Name, icon and AllowHidden. The ZoomLevels entity 304 includes a ZoomLevel attribute and a Description property. The PushpinEntities entity 306 includes a PushPinID attribute and properties of Name, Latitude, Longitude, ZoomLevel, Label, Title, TypeID, Visible, SourceID and PopupData. The PushpinParent entity 308 includes attributes of PushPinID and ParentID. The PushpinEntities entity 306 includes relationships to the Types entity 302, ZoomLevels entity 304, and PushpinParent entity 308.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

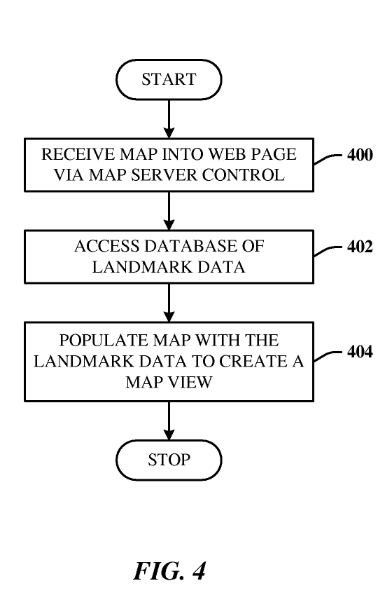

FIG. 4 illustrates a computer-implemented method of providing a map in a web page. At 400, a map is received into a web page via a map server control. At 402, a database of landmark data is accessed. At 404, the map is populated with the landmark data to create a map view.

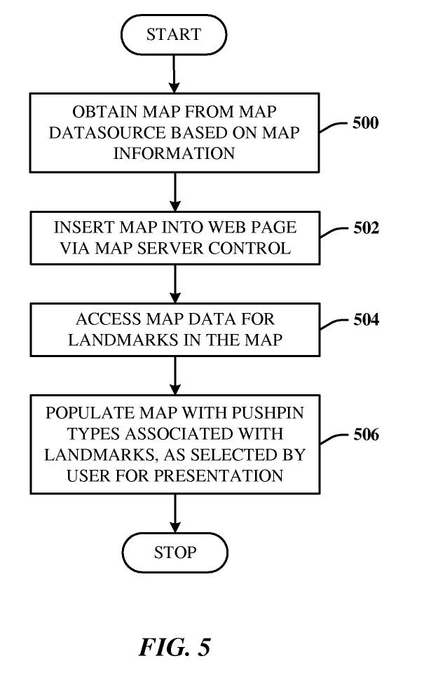

FIG. 5 illustrates a method of obtaining and populating a map with pushpin types and map data. At 500, obtain map from a map datasource based on map information. The datasource can be a web-based map application system (e.g., a 3D map website that provides 2D and/or 3D rendering of geographical maps), or a local datasource of maps. The map information can be latitude/longitude information, intersection information, address information, identifier for the source (the map application system), and so on. At 502, the map is inserted into the web page via the map server control. At 504, map data is accessed for landmarks associated with the map. At 506, the map is populated with pushpin types associated with the landmarks, as selected by the user for presentation.

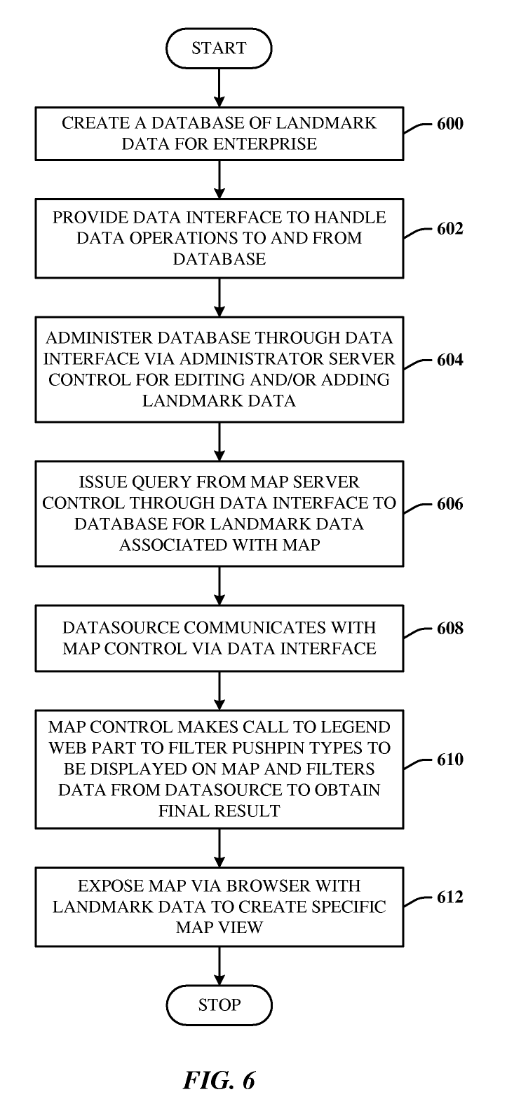

FIG. 6 illustrates a method of managing a database of landmark data for a mapping process. At 600, a database of landmark data is created for an enterprise.

The landmark data relates to all landmarks of the enterprise campus, for example, administration building, engineering buildings, cafeteria buildings, company stores, visitor center, libraries, parking and banking facilities. At 602, a data interface is provided to handle data operations to and from the database. At 604, the database is administered through the data interface via an administrator server control for editing and/or adding the landmark data. At 606, a query is issued by a map server control through the data interface to the database for landmark data associated with the map. At 608, the datasource communicates with the map control via the data interface. At 610, the map control makes a call to the legend web part to filter the pushpin types to be displayed on the map and filters data from the datasource to obtain the final result. At 612, the map is exposed with landmark data to create a specific map view.

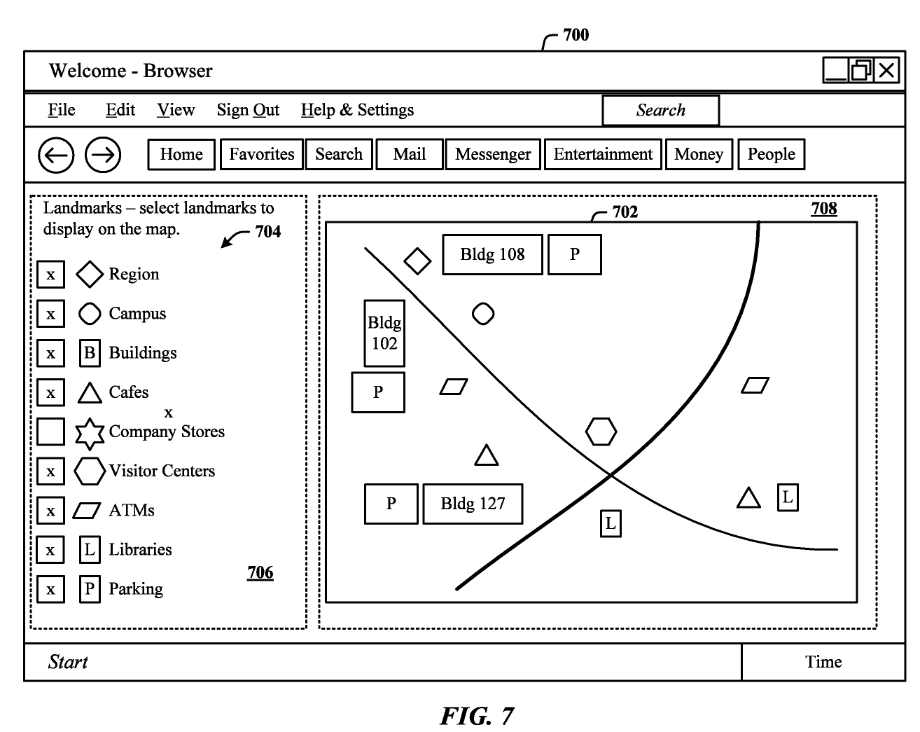

FIG. 7 illustrates an exemplary web page 700 exposed via a browser that incorporates an enterprise map 702 populated by pushpin landmark data 704. The user selects/deselects the pushpins for landmark data using the legend web part (or server control) 706. The map 702 is presented via a map web part 708.

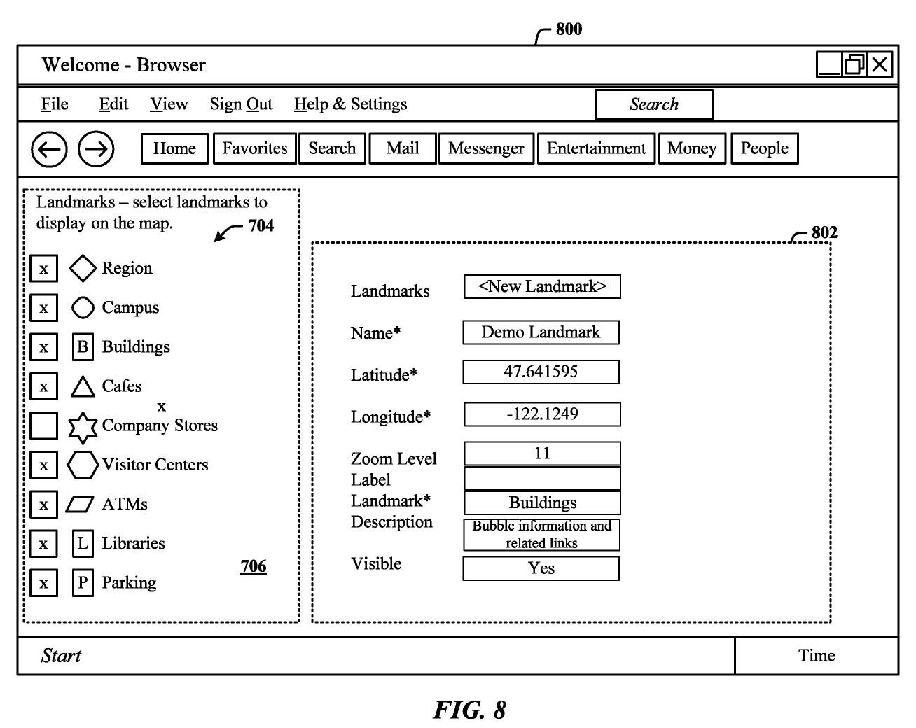

FIG. 8 illustrates an exemplary web page 800 exposed via the browser that incorporates an administrator web part 802. Here, a new building has come up and data for that building is entered into the database.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

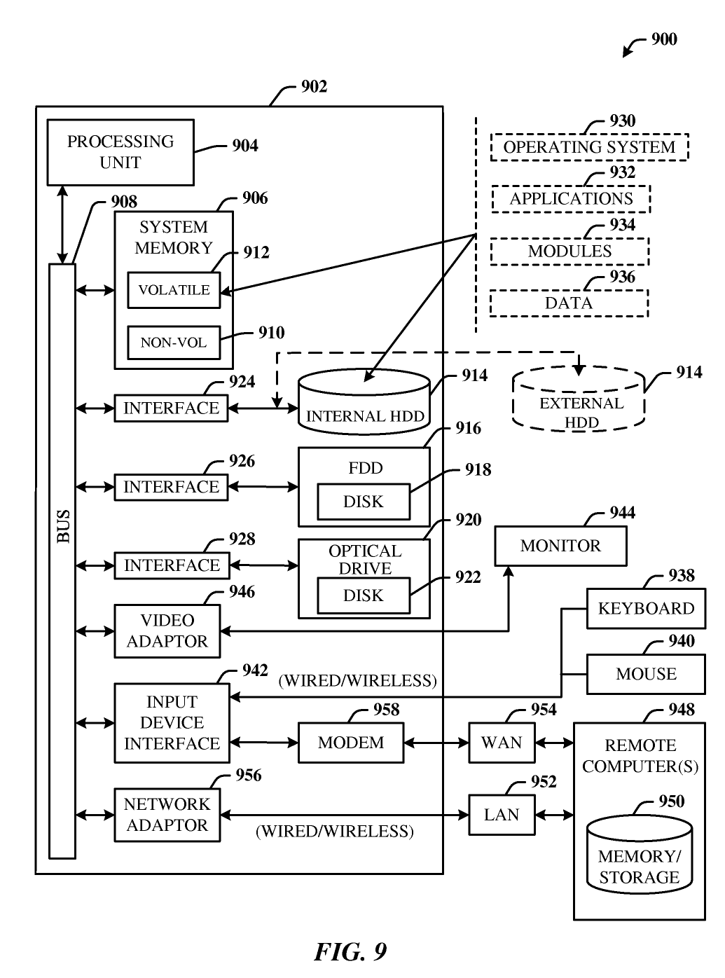

Referring now to FIG. 9, there is illustrated a block diagram of a computing system 900 operable to support the disclosed map server control system. In order to provide additional context for various aspects thereof, FIG. 9 and the following discussion are intended to provide a brief, general description of a suitable computing system 900 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 9, the exemplary computing system 900 for implementing various aspects includes a computer 902 having a processing unit 904, a system memory 906 and a system bus 908. The system bus 908 provides an interface for system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 can include non-volatile memory (NON-VOL) 910 and/or volatile memory 912 (e.g., random access memory (RAM)). A basic input/output system (BIOS) can be stored in the non-volatile memory 910 (e.g., ROM, EPROM, EEPROM, etc.), which BIOS stores the basic routines that help to transfer information between elements within the computer 902, such as during start-up. The volatile memory 912 can also include a high-speed RAM such as static RAM for caching data.

The computer 902 further includes an internal hard disk drive (HDD) 914 (e.g., EIDE, SATA), which internal HDD 914 may also be configured for external use in a suitable chassis, a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 912, including an operating system 930, one or more application programs 932, other program modules 934, and program data 936. Where the computer 902 is a server, the applications, 932, modules 934, and data 936 can include the web part 102, map 104, data interface 108, the map web part 206, admin web part 204 and legend web part 202. The internal HDD 914 can store the landmark (or pushpin) data according to the schema 300 of FIG. 3. The remote computers 948 can include the map application system having the associated map datasource 114.

Where the computer 902 is the client, the applications 932 can include a browser via which the web parts (or server controls) are employed to present the maps, landmark data and specific map views.

All or portions of the operating system, applications, modules, and/or data can also be cached in the volatile memory 912. It is to be appreciated that the disclosed architecture can be implemented with various commercially available operating systems or combinations of operating systems.

A user can enter commands and information into the computer 902 through one or more wire/wireless input devices, for example, a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, etc.

A monitor 944 or other type of display device is also connected to the system bus 908 via an interface, such as a video adaptor 946. In addition to the monitor 944, a computer typically includes other peripheral output devices (not shown), such as speakers, printers, etc.

The computer 902 may operate in a networked environment using logical connections via wire and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, is connected to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented map rendering system, comprising:
a web part for presenting a map in a web page; and
a data interface for managing access to a datasource of map data, the map data used to populate the map to present a specific map view.

2. The system of claim 1, wherein the datasource includes pushpin data related to landmarks that are rendered in the map view.

3. The system of claim 1, wherein the web part is a map web part that retrieves the map data from a map datasource.

4. The system of claim 3, wherein the map web part facilitates a data interface that is modified using a browser application.

5. The system of claim 1, further comprising an administrator web part for managing the data in the datasource by adding and editing the map data manually.

6. The system of claim 1, wherein the map data includes real estate and landmark information specific to an enterprise in which the rendering system is employed.

7. The system of claim 1, wherein the web part and the data interface facilitate presentation of maps in a collaboration and document management platform.

8. The system of claim 1, further comprising a legend web part that provides a list of pushpin type data to the web part for selection.

9. The system of claim 1, wherein the web part queries the data interface for pushpin data to render in the map view.

10. A computer-implemented map rendering system, comprising:
a map web part for presenting a map view in a web page;
a data interface for managing a datasource of pushpin data used to populate the map view; and
a legend web part for signaling the map web part of a plurality of landmarks to render as the pushpin data in the map view.

11. The system of claim 10, further comprising an administrator web part for managing the data in the datasource and facilitating editing of the pushpin data manually.

12. The system of claim 10, wherein the map rendering system is part of a web-based collaboration and document management environment.

13. The system of claim 10, wherein the data interface facilitates access to a corporate database having a schema different than a schema of the datasource.

14. The system of claim 10, wherein the data interface facilitates communications with the datasource and provide data to be rendered in the map view.

15. A computer-implemented method of providing a map in a web page, comprising:
receiving a map into a web page via a map server control;
accessing a database of landmark data; and
populating the map with the landmark data to create a map view.

16. The method of claim 15, further comprising retrieving the map from a map application.

17. The method of claim 15, further comprising issuing a query for processing against the database to obtain the landmark data.

18. The method of claim 15, further comprising administering the database by adding and editing landmark data of the database using an administrator server control.

19. The method of claim 15, further comprising sending a list of the landmark data to the map server control for selection and presenting of the selected landmark data as pushpins on the map view.

20. The method of claim 15, further comprising routing data handling operations for the landmark data through a data interface.
